(19) United States
(12) Patent Application Publication
(10) Pub. No.: US 2009/0326939 A1
(43) Pub. Date: Dec. 31, 2009

(54) SYSTEM AND METHOD FOR TRANSCRIBING AND DISPLAYING SPEECH DURING A TELEPHONE CALL

(75) Inventors: Victoria M. Toner, Sheboygan, WI (US); Johnny Hawkins, Kansas City, MO (US); Rich Schemerhorn, Overland Parks, KS (US); Shekhar Gupta, Overland Park, KS (US); Mike A. Roberts, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/146,096

(22) Filed: Jun. 25, 2008

(51) Int. Cl. G10L 15/26

(52) U.S. Cl. 704/235

(57) ABSTRACT

A system and method for providing speech transcription to a user during a telephone call may include a receiver configured to receive a telecommunications signal forming a telephone call. The telecommunications signal communicates speech data representative of words spoken by a telephone call participant. A processing unit may be in communication with the receiver and be configured to transcribe the speech data representative of words into text. A display unit may be in communication with the processing unit and be configured to display the text for a user during the telephone call.

### BACKGROUND OF THE INVENTION

1. Field of the Invention

The present general inventive concept relates to a system and method to use a telephone, such as a voice over Internet Protocol (VoIP) phone, and more particularly, to a system that is configured to provide speech to text capabilities.

2. Description of the Related Art

The use of and development of communications has grown nearly exponentially in recent years. The growth has been fueled by larger networks with more reliable protocols and better communications hardware available to service providers and consumers. Users have similarly grown to expect better communications with rapid access to information related to their communications. These heightened expectations are driven by the desire of users for new technology that provides increased efficiency and effectiveness.

While telephone users now expect clear audio signals so that they user can hear and understand the party with whom they are communicating, breakdowns in communication still occur. The breakdowns may result from a poor connection, poor communication skills, limits of telephone technology such as a user's inability to view the speaker during a telephone conversation, and the like.

For instance, one or more parties on a telephone or conference call may have a speech impediment, poor grasp of others' language, or does not speak others' language. Further, one or both of the calling parties may be in an environment that has excessive background noise that interferes with the ability to communicate satisfactorily.

The limits of phone technology are also problematic. For instance, if there are multiple participants during a conference call, a breakdown in communication may result from one or more participants' inability to distinguish one participant from another. This issue is especially problematic given the commonplace of conference calls in today's workplace.

Technology to address breakdowns in communicate has not significantly improved with changing technology. Equipping a user with an increased amount of information so that the user may better understand another party would enhance the user's ability to communicate with the other party.

### SUMMARY

To overcome communications problems during telephone calls, the principles of the present invention provide for converting speech to text during a telephone call and displaying the text for a party on the telephone call. The speech-to-text conversion may generate the same or different language as the speech. By converting and displaying the text, one or more parties on the telephone call may more easily understand other parties on the call and have a record of the conversation.

An embodiment of a system for providing speech transcription to a user during a telephone call may include a receiver configured to receive a telecommunications signal forming a telephone call. The telecommunications signal communicates speech data representative of words spoken by a telephone call participant. A processing unit may be in communication with the receiver and be configured to transcribe the speech data representative of words into text. A display unit may be in communication with the processing unit and be configured to display the text for a user during the telephone call.

An embodiment of a process for providing speech transcription to a user during a telephone call may include receiving a telecommunications signal forming a telephone call. The telecommunications signal communicates speech data representative of words. The speech data representative of words may be transcribed into text, and displayed for a user during the telephone call.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIGS. 1A and 1B are illustrations of a system that includes a personal computer in communication with a telephone;

FIG. 2 is a block diagram of an illustrative computing system configured to provide speech to text transcription functionality in accordance with the principles of the present invention;

FIG. 3 is a block diagram of illustrative modules that may be utilized to perform transcription functionality in accordance with the principles of the present invention; and

FIG. 4 is a flow diagram of an illustrative process for transcribing speech during a telephone call in accordance with the principles of the present invention.

### DETAILED DESCRIPTION OF THE DRAWINGS

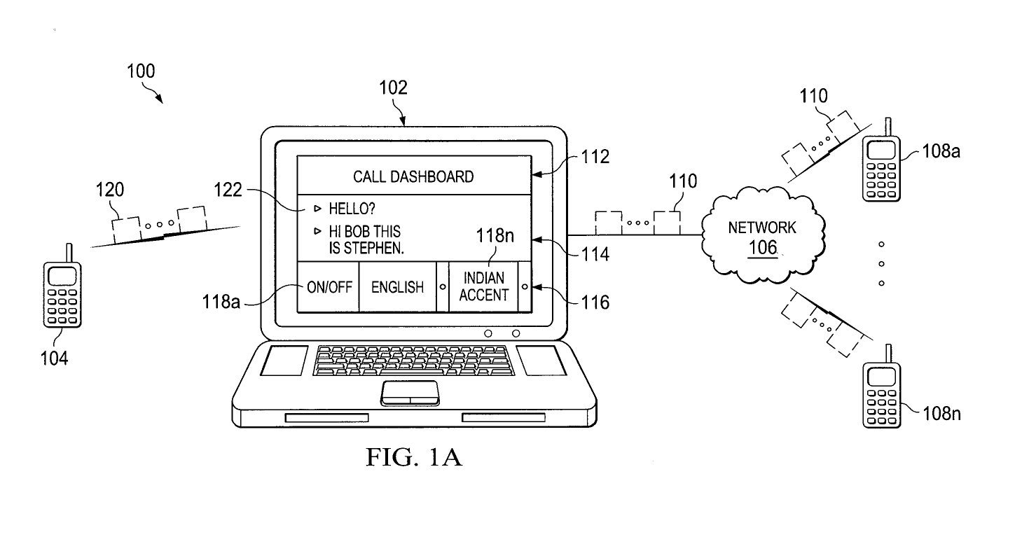

FIG. 1A is an illustration of an illustrative system 100 that includes a personal computer 102 in communication with a telephone 104. The telephone 104 may be a wireless telephone that is configured to communicate with the personal computer 102 using voice over Internet Protocol (VoIP) communications. Alternatively, the telephone 104 may be a telephone or handset that communicates with the personal computer 102 via a wired connection. Alternatively, the personal computer 102 may execute a soft-telephone, which is software that includes telephone functionality and may enable a user to use the soft-telephone via a speaker telephone, headset, wireless telephone, or any other telecommunications device configured to enable the user to place calls, receive calls, or perform any other telephone functionality, as understood in the art.

The personal computer 102 may be in communication with a network 106 to communicate with other telephones 108a-108n (collectively 108) using data packets 110 or other communications protocols, as understood in the art. In one embodiment, the network 106 is the Internet. In addition, the network 106 may include other telecommunications networks, such as mobile communications networks and public switched telephone network (PSTN).

In one embodiment, the personal computer 102 may be configured to transcribe speech during a call and display text representative of the speech on the personal computer 102. The application may provide a graphical user interface (GUI) 112 that includes a transcription region 114 and control region 116. The control region 116 may include one or more control elements 118a-118n that enable the user to selectably turn the transcription feature on and off, select a language from which the transcription is being performed, select a preestablished accent, for example. As shown in the transcription region 114, a telephone conversation is being transcribed. The transcribed conversation may be performed substantially real-time and enable the user to view the transcription during the conversation and store the transcribed conversation for later use.

Because the personal computer 102 (or other communications device) is capable of recording the telephone call, the user may be provided with recorder controls that enable the user to replay the recorded telephone call during the telephone call. By enabling a user to replay the telephone call during the telephone call, a user who is unable to understand the person with whom he or she is speaking due to a bad connection, accent of the other person, or otherwise, may simply rewind and play the portion of the conversation that he or she did not hear properly, thereby not having to ask the other person to restate what he or she said.

In the embodiment shown in FIG. 1A, because the telephone 104 communicates via the personal computer 102 with data packets 120, which represent a speech signal or data, the personal computer 102 may determine whether voice communication data is being communicated to or from telephone 104. That is, voice communication data being communicated in data packets 110 or 120 may be readily determined by software being executed by the personal computer 102 and, in response to determining which direction the speech data is being communicated (i.e., which user is speaking), the software may display an indicia 122 before text of transcribed speech in the region 114. In one embodiment, the indicia may represent direction of the transcribed speech or a person speaking. It should be understood that if the telephone 104 that is communicating via the personal computer 102 is configured with a fast enough processor and memory, the telephone 104 may perform the same or similar functionality as the personal computer 102. For example, if the telephone 104 is a VoIP telephone that has a display, the VoIP telephone may transcribe the speech of the telephone call and display the transcription of the speech during the telephone call. Telephones that use other communications protocols may similarly perform the transcription and display speech feature. In an alternative embodiment, if the telephone 104 is configured with a fast enough processor and memory and communicates via a wireless access point or wired connection to the network 106 as opposed to communicating via the personal computer 102, the telephone 104 may perform the same or similar functionality as provided by the personal computer 102.

FIG. 1B is an alternative configuration of FIG. 1A of a system 124 configured to perform transcription services on a server 126 located on network 128 via which telephone 130 may communicate with one or more telephones 132a-132n (collectively 132). In operation, a user using telephone 130 may communicate data packets 134 with one or more telephones 132. An application being executed on telephone 130 may cause data packets 134 to be routed via server 126, which may perform transcription services during the telephone call. The server 126 may include the same or similar functionality as described with respect to the personal computer 102 of FIG. 1A. However, rather than utilizing resources of a computer device to which the telephone 130 is in communication, the server 126 may perform the transcription services and communicate the transcribed text to the telephone 130 for display thereon in an electronic display 136. In an alternative embodiment, if the telephone 130 were communicating via a computing device, such as a personal computer, then the computing device may present a GUI with a transcription region for displaying text of the telephone call.

In one embodiment, the server 126 may be configured as a conference call system that enables two or more callers to perform a conference call by dialing into a telephone number that then connects the callers into a conference call that each caller may listen. The server 126 may enable one or more of the callers into the conference call to selectively turn on a transcription service to transcribe in a substantially real-time manner and communicate the transcription to the user(s) during the conference call. Each of the callers who receive the transcription may utilize the transcription to better follow along with the conference call and save the conference call transcription for later review. In one embodiment, the server 126 may be configured to identify each user through his or her speech “signature” and allow each user to identify or associate a name with each caller. So, for example, if three callers on the conference call are speaking, the server 126 may be configured to enable one or more of the callers to enter the names of each of the callers, and the server 126 may automatically identify and associate or tag the name of each of the callers with text transcribed from each of the respective callers.

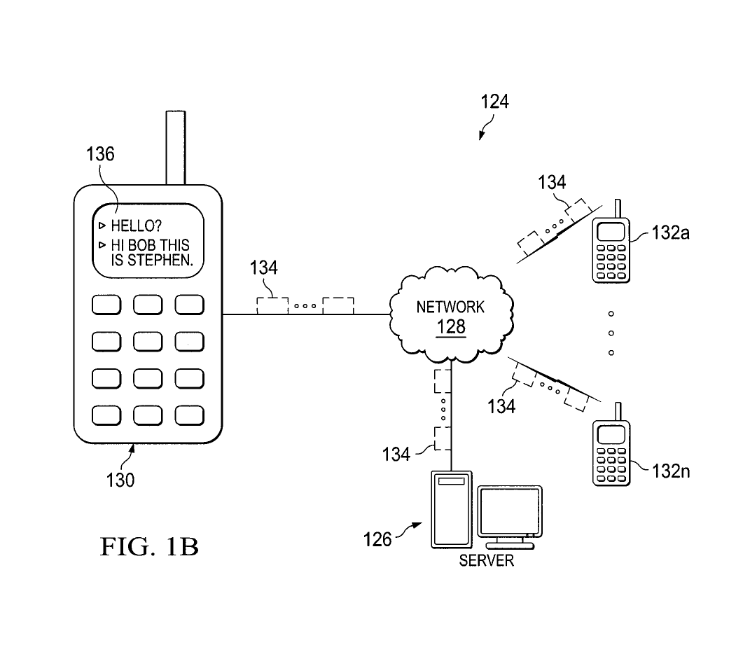

FIG. 2 is a block diagram of an illustrative computing system 200 configured to provide speech to text transcription functionality in accordance with the principles of the present invention. The computing system 200 may include a processing unit 202 that executes software 204 that is configured to assist in transcription services during telephone calls in accordance with the principles of the present invention. The processing unit 202 may be in communication with a memory 206 to store data and software, input/output (I/O) unit 208 to communicate data, such as speech data, over a network, and storage unit 210 to store information. The storage unit 210 may store data repositories 212a-212n (collectively 212). The data repositories may be databases, such as relational databases, as understood in the art. The data repositories 212 may store data, such as dictionaries, translation dictionaries, speech transcription data, or any other information that enables the processing unit 202 to look-up words in performing speech transcription and translation services. In one embodiment, the memory 206 may be utilized to look-up and store data from the data repositories 212 for improved performance by the processing unit 202 in performing transcription of speech to text. In one embodiment, the computing system is a computing device, such as a personal computer, that may be utilized by a user of a telephone, such as a Wi-Fi, VoIP, or session initiated protocol (SIP) telephone, as understood in the art. Alternatively, the computing system 200 may be a server operating on a network, such as the Internet, and the software 204 may be utilized to perform transcription services and/or conference call services, as understood in the art. Furthermore, the computing system 200 may itself be a telephone. Although shown as a single computing system 200 with a single processing unit 202, the principles of the present invention provide for one or more computing systems that include one or more processing units to perform the speech transcription functionality as described herein.

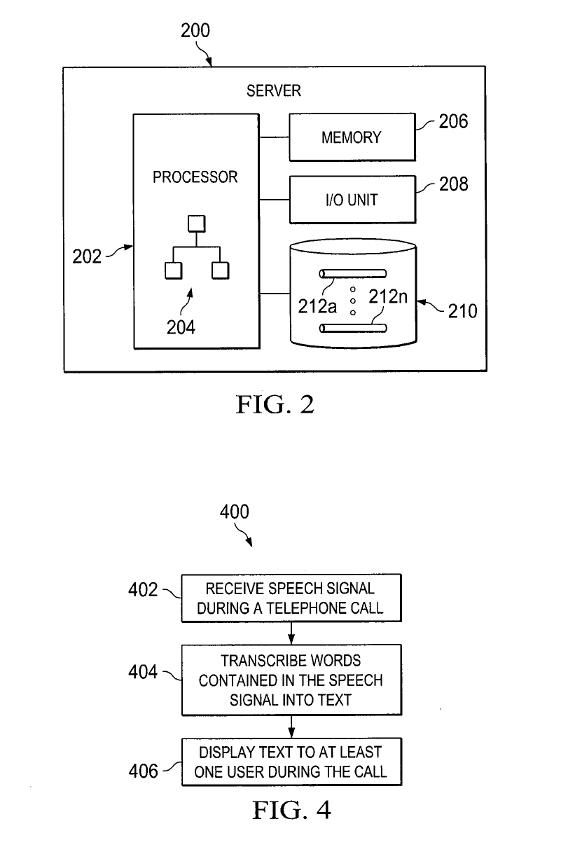

FIG. 3 is a block diagram of illustrative modules 300 that may be utilized to perform speech transcription functionality in accordance with the principles of the present invention. A convert speech to text module 302 may be utilized to convert speech to text during a telephone call between two or more users. Although shown as a single module, the convert speech to text module 302 may be configured with more than one module to convert speech of any language into text. For example, the convert speech to text module 302 may convert English or Spanish into text in English or Spanish, respectively. A translate between select languages module 304 may be configured to translate text produced by the convert speech to text module 302 into a different language (e.g., English to Spanish or Spanish to English). By utilizing a language translation module, such as module 304, the convert speech to text module 302 may be off-loaded from having to transcribe speech into more than one language.

A train conversion module 306 may be configured to enable a user to train the convert speech to text module 302 to improve accuracy of the transcriptions. The train conversion module 306 may be utilized to train the module 302 by one or more users. For example, if multiple people use a single telephone or on a conference call, then each user may train the system with his or her voice. In addition, the train conversion module 306 may be used by another user at a different location who calls into a user. The train conversion module 306 may be trained by requesting a user to speak specific words or phrases so that the system is more easily able to identify specific words spoken by the user, as understood in the art.

A speaker type selector module 308 may provide for preestablished types of speakers who fall into a certain category. For example, the speaker type selector module 308 may enable a user to identify speakers as Southern, Northeastern, Midwestern, or ones from different countries. For example, if a user is from India and speaks English with a certain accent, the system may be preprogrammed or pre-trained such that the accent is accommodated for a party who speaks English with an Indian accent and the system is better able to transcribe his or her speech. In addition, the speaker type selector module 308 may enable a user to specify demographics of one or more users. The demographics may include gender, age, race, country of origin, or any other demographic that may enable the convert speech to text module 302 to better transcribe each parties' speech.

A conference call speaker identifier module 310 may be configured to automatically identify which speaker is being transcribed, thereby identifying text being spoken by each speaker. In one embodiment, the conference call speaker identifier module 310 may be configured to recognize a speech pattern, such as a formant pattern of a speaker, where a formant is generally defined by three dominant tones in a speaker's voice. Thereafter, each time the convert speech to text module 302 is utilized to convert speech of a user into text, the text may be displayed in association with an indicia, such as “Speaker One.” An associate name with speaker module 312 may be configured to enable a user to enter a name that the conference call speaker identifier module 310 or other module may utilize to display a name (e.g., “Peter:”), rather than any other indicia (e.g., “Speaker One”).

A display GUI module 314 may be configured to display a graphical user interface (GUI) on a computing system or telephone, as shown in FIGS. 1A and 1B, for example. The display GUI module 314 may display a transcription region showing the text of transcribed speech for a user to view during the telephone conversation. The display GUI module 314 may also provide for selectable control elements for a user to select before or during a telephone call. For example, one selectable element may provide for selectably turning on and off transcription functionality performed by the convert speech to text module 302, displaying the transcribed text in a particular language, associating a name with a speaker or user, saving the transcribed text, or otherwise.

A store transcription module 316 may be configured to store text transcribed from speech during a telephone call, as understood in the art. The stored transcription may be printed or otherwise utilized by a user thereafter.

A host conference call module 318 may be configured to enable multiple users call into a conference call, as understood in the art. One or more conference call participants may utilize the transcription and translation capabilities provided by the modules 300 during the conference call.

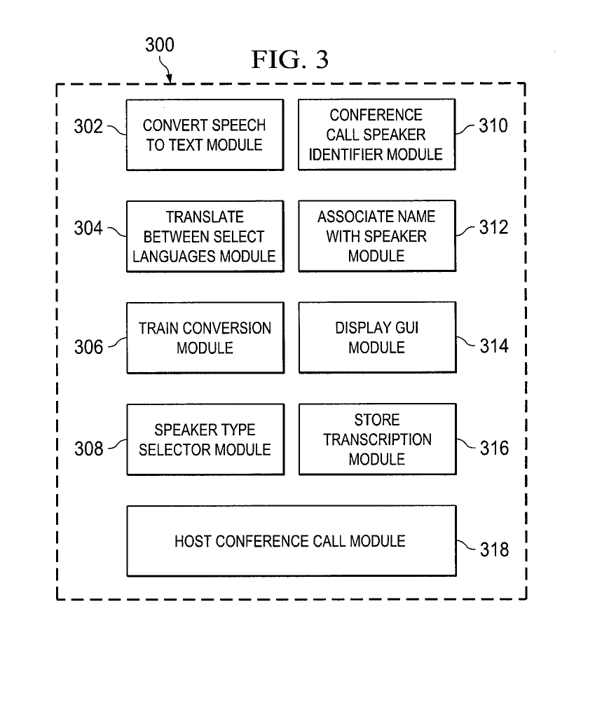

FIG. 4 is a flow diagram of an illustrative process 400 for transcribing speech during a telephone call in accordance with the principles of the present invention. The process 400 starts at step 402, where speech data or signal is received during a telephone call. The speech signal may be received in data packets over a communications network, such as the Internet. The speech signal may be received at a user who has placed or received the telephone call at a network node, such as a server, on the network. At step 404, words contained in the speech signal may be transcribed into text. At step 406, the text may be displayed to at least one of the users during the telephone call. In one embodiment, the text may be displayed in the same language as contained in the speech signal. Alternatively, the text may be displayed in a language different from that received in the speech signal. In one embodiment, the text may be displayed at the same location as transcribed. Alternatively, the text may be communicated to a different location as transcribed (e.g., transcribed at a network node and communicated to a computing device, telephone, or both). In displaying the text, the text may be displayed in a graphical user interface and displayed in a window with a scrollbar, for example, that enables a user to scroll throughout the text during the telephone call, thereby assisting a user during the telephone call with being able to read what he or she or another party said during the telephone call.

Although a few embodiments of the present general inventive concept have been illustrated and described, it will be appreciated by those skilled in the art that changes may be made in these exemplary embodiments without departing from the principles of the general inventive concept, the scope of which is defined in the appended claims and their equivalents.

What is claimed is:

1. A system for providing speech transcription to a user during a telephone call, said system comprising:
a receiver configured to receive a telecommunications signal forming a telephone call, the telecommunications signal communicating speech data representative of words;
a processing unit in communication with said receiver and configured to transcribe the speech data representative of words into text; and
a display unit in communication with said processing unit and configured to display the text for a user during the telephone call.

2. The system according to claim 1, wherein the words contained in the speech data are in a first language, and said processing unit is configured to display text in the first language.

3. The system according to claim 2, wherein said processing unit is configured to selectably display text in a second language.

4. The system according to claim 1, wherein said processing unit is further configured to:
generate data packets including data representative of the text; and
communicate the data packets over a network for display of the text on said display unit.

5. The system according to claim 1, wherein said processing unit is further configured to enable a user to select a preestablished accent representative of a telephone call participant having the same or similar accent based on demographics of the telephone call participant.

6. The system according to claim 5, wherein the demographics include a country of origin of the telephone call participant.

7. The system according to claim 1, wherein said processing unit is further configured to host a conference call.

8. The system according to claim 1, wherein said display unit is located on at least one of a computing device and a telephone.

9. The system according to claim 1, wherein the telecommunications signal is a voice over Internet Protocol signal.

10. The system according to claim 1, wherein said processing unit is further configured to:
enable a user to identify each participant on the telephone call; and
display the identified participant prior to displaying text associated with speech spoken by each respective identified participant.

11. A method for providing speech transcription to a user during a telephone call, said method comprising:
receiving a telecommunications signal forming a telephone call, the telecommunications signal communicating speech data representative of words;
transcribing the speech data representative of words into text; and
displaying the text for a user during the telephone call.

12. The method according to claim 11, wherein transcribing the speech data includes transcribing words in a first language, and wherein displaying the text includes displaying the text in the first language.

13. The method according to claim 12, wherein further comprising selectably displaying the text in a second language.

14. The method according to claim 11, further comprising:
generating data packets including data representative of the text; and
communicating the data packets over a network for displaying the text.

15. The method according to claim 11, further comprising enabling a user to select a pre-established accent representative of a telephone call participant having the same or similar accent based on demographics of the telephone call participant.

16. The method according to claim 15, further comprising displaying selectable preestablished accents to the user for selection based on a country of origin of the telephone call participant.

17. The method according to claim 11, further comprising hosting a conference call.

18. The method according to claim 11, wherein receiving, transcribing, and displaying is performed on at least one of a computing device and a telephone.

19. The method according to claim 11, wherein receiving the telecommunications signal includes receiving a voice over Internet Protocol signal.

20. The method according to claim 11, wherein further comprising:
enabling a user to identify each participant on the telephone call; and
displaying the identified participant prior to displaying text associated with speech spoken by each respective identified participant.
